(19) United States
(12) Patent Application Publication
(10) Pub. No.: US 2022/0407096 A1
(43) Pub. Date: Dec. 22, 2022

(54) FUEL CELL SYSTEM AND METHOD FOR CONTROLLING SAME

(71) Applicant: MITSUBISHI HEAVY INDUSTRIES, LTD., Tokyo (JP)

(72) Inventors: Hiroyuki OZAWA, Kanagawa (JP); Yasushi IWAI, Tokyo (JP); Kimi KODO, Kanagawa (JP); Kenta ARAKI, Kanagawa (JP)

(21) Appl. No.: 17/637,274

(22) PCT Filed: Jan. 27, 2021
(86) PCT No.: PCT/JP2021/002865

§ 371 Date: Feb. 22, 2022

(30) Foreign Application Priority Data
Feb. 27, 2020 (JP) 2020-032258

(51) Int. Cl. H01M 8/04746; H01M 8/04089; H01M 8/04111

(52) U.S. Cl. CPC H01M 8/04783; H01M 8/04104; H01M 8/04111

(57) ABSTRACT

The purpose of the present invention is to provide fuel cell system capable of stably executing differential pressure control and having a simplified configuration, and method for controlling the same. Fuel cell system equipped with fuel cell, a turbocharger, exhaust fuel gas line, exhaust oxidizing gas line, combustion gas supply line for supplying combustion gas discharged from a combustor to a turbine, oxidizing gas supply line for supplying oxidizing gas compressed by a compressor to cathode, a regulator valve provided to the exhaust fuel gas line, and a control unit for controlling the differential pressure between the pressure of the cathode of the fuel cell and the pressure of the anode thereof by controlling the regulator valve, wherein the exhaust oxidizing gas line is not provided with venting system for discharging exhaust oxidizing gas outside the system.

### TECHNICAL FIELD

The present disclosure relates to fuel cell system and control method therefor.

### BACKGROUND ART

Fuel cell that generates power by chemically reacting fuel gas with oxidizing gas has characteristics such as excellent power generation efficiency and environmental friendliness. Among fuel cells, solid oxide fuel cell (hereinafter, referred to as SOFC) generates power by using ceramics such as zirconia ceramics as an electrolyte, supplying hydrogen, town gas, natural gas, petroleum, methanol, and gas such as gasified gas produced from carbonaceous raw materials by a gasification facility, as fuel gas, and reacting in high temperature atmosphere of approximately 700° C. to 1000° C. (For example, PTL 1, PTL 2, PTL 3, and PTL 4)

### CITATION LIST

### Patent Literature

[PTL 1] Japanese Unexamined Patent Application Publication No. 2013-211265

[PTL 2] Japanese Unexamined Patent Application Publication No. 2016-95940

[PTL 3] Japanese Unexamined Patent Application Publication No. 2018-32472

[PTL 4] Japanese Patent No. 6591112

### SUMMARY OF INVENTION

### Technical Problem

SOFC can improve power generation efficiency by combining with an internal combustion engine, and some are combined with, for example, a gas turbine (for example, a micro gas turbine). The SOFC needs to properly keep differential pressure between anode (fuel electrode) and cathode (air electrode) stable. However, in case where power generation system combining the SOFC and the micro gas turbine causes trip for some reason, a generator of the micro gas turbine becomes unloaded, and there is possibility that protection measures for the micro gas turbine are required. Therefore, in preparation for the occurrence of trip, it is necessary to provide discharge system, a shutoff valve, and the like that release exhaust oxidizing gas discharged from the cathode of the SOFC to the atmosphere (outside the system). However, the shutoff valve is an expensive device and needs to control the differential pressure between the cathode and the anode within predetermined value. Therefore, in system including the SOFC, it is desired to simplify the configuration while maintaining stable operating state.

The present disclosure has been made in view of such circumstances, and the object of the present disclosure is to provide fuel cell system capable of stably performing differential pressure control and control method therefor.

### Solution to Problem

According to first aspect of the present disclosure, there is provided fuel cell system including: fuel cell having cathode (air electrode) and anode (fuel electrode); a turbocharger having a turbine and a compressor; exhaust fuel gas line for supplying exhaust fuel gas discharged from the fuel cell to a combustor; exhaust oxidizing gas line for supplying exhaust oxidizing gas discharged from the fuel cell to the combustor; combustion gas supply line for supplying combustion gas discharged from the combustor to the turbine; oxidizing gas supply line for supplying oxidizing gas compressed by the compressor to the cathode by rotationally driven by the turbine; a regulating valve provided on the exhaust fuel gas line; and a control unit that controls the regulating valve to control differential pressure between pressure of the cathode and pressure of the anode in the fuel cell, in which vent system that releases the exhaust oxidizing gas to outside of the system is not provided on the exhaust oxidizing gas line.

According to second aspect of the present disclosure, there is provided method for controlling fuel cell system including fuel cell having cathode and anode, a turbocharger having a turbine and a compressor, exhaust fuel gas line for supplying exhaust fuel gas discharged from the fuel cell to a combustor, exhaust oxidizing gas line for supplying exhaust oxidizing gas discharged from the fuel cell to the combustor, combustion gas supply line for supplying combustion gas discharged from the combustor to the turbine, oxidizing gas supply line for supplying oxidizing gas compressed by the compressor to the cathode by rotationally driven by the turbine, and a regulating valve provided on the exhaust fuel gas line, in which vent system that releases the exhaust oxidizing gas to outside of the system is not provided on the exhaust oxidizing gas line, the method including: controlling the regulating valve to control differential pressure between pressure of the cathode and pressure of the anode in the fuel cell.

### Advantageous Effects of Invention

According to the present disclosure, it is possible to stably perform the differential pressure control and to simplify the configuration.

### BRIEF DESCRIPTION OF DRAWINGS

FIG. 1 shows example of a cell stack according to embodiment of the present disclosure.

FIG. 2 shows example of an SOFC module according to the embodiment of the present disclosure.

FIG. 3 shows example of an SOFC cartridge according to the embodiment of the present disclosure.

FIG. 4 shows a schematic configuration of fuel cell system according to the embodiment of the present disclosure.

FIG. 5 shows configuration example of a catalytic combustor according to the embodiment of the present disclosure.

FIG. 6 shows example of a hardware configuration of a control unit according to the embodiment of the present disclosure.

FIG. 7 shows example of flowchart of procedure of differential pressure control according to the embodiment of the present disclosure.

FIG. 8 shows example of procedure to deal with the abnormal process according to the embodiment of the present disclosure.

FIG. 9 shows example of flowchart of procedure of differential pressure control according to the embodiment of the present disclosure.

### DESCRIPTION OF EMBODIMENTS

Hereinafter, one embodiment of the fuel cell system and the method for controlling the same according to the present disclosure will be described with reference to the drawings.

In the following, for convenience of description, the positional relationship between each of the configuration elements described using the expressions “up” and “down” on the paper surface indicates perpendicularly upper side and perpendicularly lower side, respectively, and perpendicular direction is not exact and includes uncertainty. In the present embodiment, regarding up-down direction and horizontal direction which can obtain the same effect, for example, the up-down direction on the paper surface is not necessarily limited to the perpendicularly up-down direction, and the direction may correspond to the horizontal direction orthogonal to the perpendicular direction.

Hereinafter, although a cylindrical (tubular) cell stack will be described as an example of a cell stack of solid oxide fuel cell (SOFC), the cell stack is not necessarily limited thereto, and may be, for example, a flat cell stack. The fuel cell is formed on a substrate, but electrode (anode (fuel electrode) 109 or cathode (air electrode) 113) may be formed thick without the substrate, and may also serve as the support part.

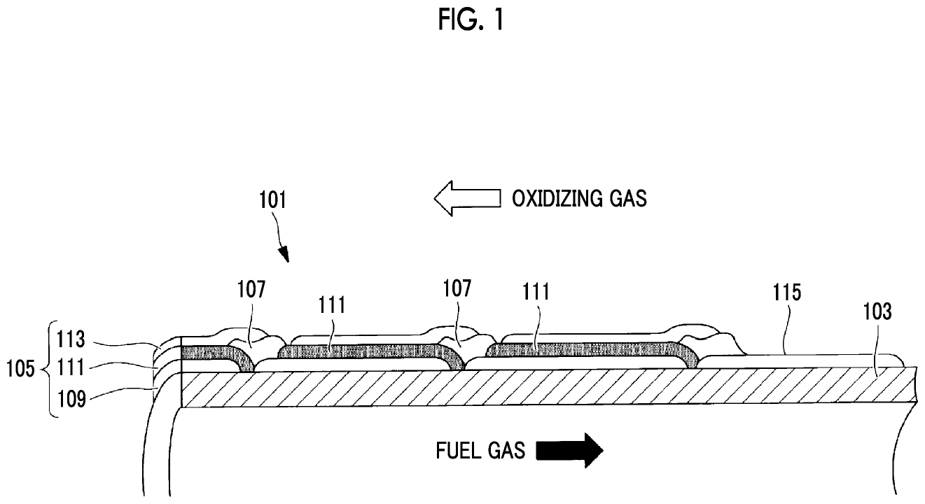

First, a cylindrical cell stack using a substrate tube will be described as example according to the present embodiment with reference to FIG. 1. When the substrate tube is not used, for example, the anode 109 may be formed thick and may also be used as the substrate tube, and the use of the substrate tube is not limited. The substrate tube in the present embodiment will be described using cylindrical shape, but the substrate tube may be tubular, and the cross section thereof is not necessarily limited to circular shape, and may be, for example, elliptical shape. A cell stack having flat tubular shape or the like in which peripheral side surface of the cylinder is vertically transposed may be used. Here, FIG. 1 illustrates the aspect of the cell stack according to the present embodiment. A cell stack 101 includes, for example, a cylindrical substrate tube 103, a plurality of fuel cells 105 formed on an outer peripheral surface of the substrate tube 103, and an interconnector 107 formed between the fuel cells 105 adjacent to each other. The fuel cell 105 is formed by laminating anode 109, solid electrolyte film 111, and cathode 113. The cell stack 101 includes lead film 115 electrically connected via the interconnector 107 to the cathode 113 of the fuel cell 105 formed at one end at the endmost part of the substrate tube 103 in axial direction, and lead film 115 electrically connected to the anode 109 of the fuel cell 105 formed at the other end at the endmost part, in the plurality of fuel cells 105 formed on the outer peripheral surface of the substrate tube 103.

The substrate tube 103 is made of porous material, for example, CaO stabilized ZrO₂ (CSZ), a mixture of CSZ and nickel oxide (NiO), Y₂O₃ stabilized ZrO₂ (YSZ), MgAl₂O₄, or the like as main components. The substrate tube 103 supports the fuel cell 105, the interconnector 107, and the lead film 115, and diffuses the fuel gas supplied to the inner peripheral surface of the substrate tube 103 to the anode 109 formed on the outer peripheral surface of the substrate tube 103 through pores of the substrate tube 103.

The anode 109 is made of an oxide of composite material of Ni and zirconia-based electrolyte material, and, for example, Ni/YSZ is used. The thickness of the anode 109 is 50 μm to 250 μm, and the anode 109 may be formed by screen-printing slurry. In this case, the anode 109 has Ni which is a component of the anode 109 and which has a catalytic reaction on the fuel gas. The catalytic reaction is performed for the fuel gas, for example, mixed gas of methane (CH₄) and steam, supplied through the substrate tube 103, and reformed to hydrogen (H₂) and carbon monoxide (CO). The anode 109 electrochemically reacts reformed gas which obtains hydrogen (H₂) and carbon monoxide (CO) with oxygen ions (O²⁻) supplied through the solid electrolyte film 111, in the vicinity of interface with the solid electrolyte film 111, and generates water (H₂O) and carbon dioxide (CO₂). At this time, the fuel cell 105 generates power via electrons released from oxygen ions.

Examples of the fuel gas that can be supplied to the anode 109 of the solid oxide fuel cell and used, include gasified gas produced by gasification facility from carbonaceous raw material such as petroleum, methanol, and coal, in addition to hydrogen (H₂), carbon monoxide (CO), and hydrocarbon gas such as methane (CH₄), town gas, and natural gas.

As the solid electrolyte film 111, YSZ having airtightness that makes it difficult for gas to pass and high oxygen ionic conductivity at high temperature is mainly used. The solid electrolyte film 111 transfers oxygen ions (O²⁻) generated at the cathode 113 to the anode 109. The film thickness of the solid electrolyte film 111 positioned on the surface of the anode 109 is 10 μm to 100 μm, and the solid electrolyte film 111 may be formed by screen-printing slurry.

The cathode 113 is made of, for example, a LaSrMnO₃-based oxide or a LaCoO₃-based oxide, and the cathode 113 is coated with slurry by screen-printing or using a dispenser. The cathode 113 dissociates oxygen in the oxidizing gas such as air to be supplied in the vicinity of the interface with the solid electrolyte film 111 and generates oxygen ions (O²⁻).

The cathode 113 can also have a two-layer configuration. In this case, the cathode layer (cathode intermediate layer) on the solid electrolyte film 111 side is made of material having high ionic conductivity and excellent catalytic activity. The cathode layer (cathode conductive layer) on the cathode intermediate layer may be made of a perovskite type oxide represented by Sr and Ca-doped LaMnO₃. In this way, it is possible to further improve the power generation performance.

The oxidizing gas is gas containing approximately 15% to 30% oxygen, and representatively, air is suitable. However, in addition to air, mixed gas of combustion exhaust gas and air, mixed gas of oxygen and air, and the like can be used.

The interconnector 107 is made of a conductive perovskite type oxide represented by M₁₋ₓLₓTiO₃ (M is alkaline earth metal element and L is lanthanoid element) such as SrTiO₃, and is formed by screen-printing slurry. The interconnector 107 is dense film such that the fuel gas and the oxidizing gas do not mix with each other. The interconnector 107 has stable durability and electric conductivity under both oxidizing atmosphere and reducing atmosphere. The interconnector 107 electrically connects the cathode 113 of one fuel cell 105 and the anode 109 of the other fuel cell 105 in the fuel cells 105 adjacent to each other, and connects the fuel cells 105 adjacent to each other in series.

Since the lead film 115 needs to have electron conductivity and to have a similar thermal expansion coefficient to that of other materials constituting the cell stack 101, the lead film 115 is made of composite material of Ni and zirconia-based electrolyte material such as Ni/YSZ or M₁₋ₓLₓTiO₃ (M is alkaline earth metal element and L is lanthanoid element) such as SrTiO₃. The lead film 115 conducts DC power generated by the plurality of fuel cells 105 connected to each other in series by the interconnector 107, to the vicinity of end portion of the cell stack 101.

The substrate tube 103 on which the slurry film of the anode 109, the solid electrolyte film 111, and the interconnector 107 is formed is co-sintered in the atmosphere. The sintering temperature is specifically set at 1350° C. to 1450° C.

Next, the substrate tube 103 on which the slurry film of the cathode 113 is formed is sintered in the atmosphere on the co-sintered substrate tube 103. The sintering temperature is specifically set at 1100° C. to 1250° C. The sintering temperature here is lower than the co-sintering temperature after forming the substrate tube 103 to the interconnector 107.

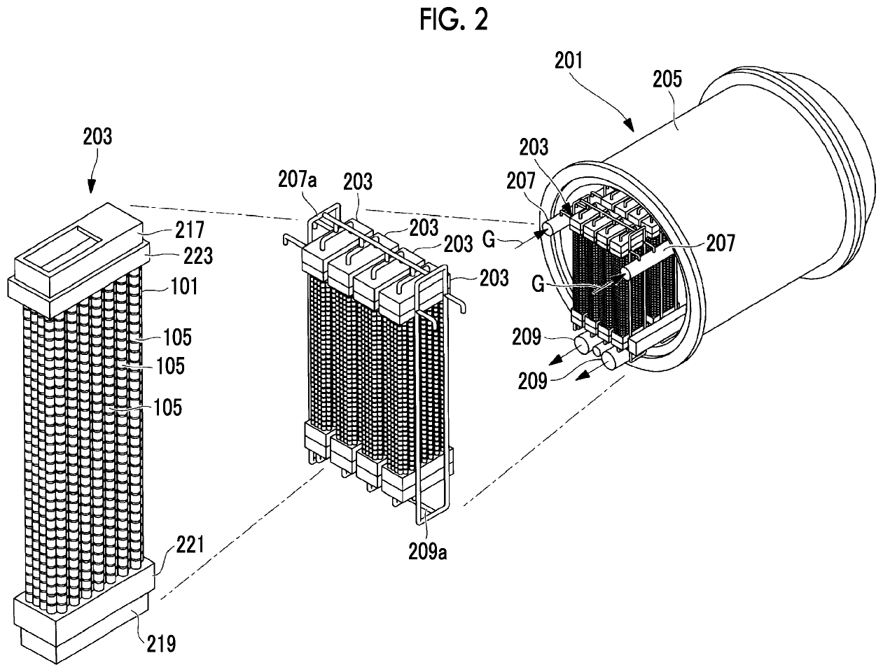

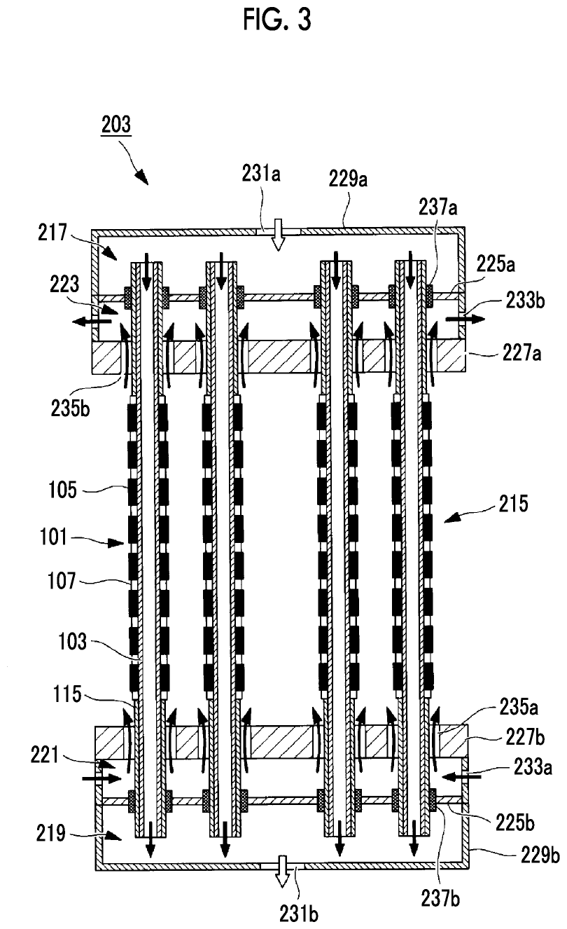

Next, an SOFC module and an SOFC cartridge according to the present embodiment will be described with reference to FIGS. 2 and 3. Here, FIG. 2 illustrates aspect of the SOFC module according to the present embodiment. FIG. 3 illustrates a sectional view of aspect of the SOFC cartridge according to the present embodiment.

As illustrated in FIG. 2, an SOFC module (fuel cell module) 201 includes, for example, a plurality of SOFC cartridges 203 (fuel cell cartridges) and a pressure vessel 205 that stores the plurality of SOFC cartridges 203 therein. Although a cylindrical SOFC cell stack 101 is described as example in FIG. 2, the cell stack is not limited thereto, and may be, for example, a flat cell stack. The SOFC module 201 includes a fuel gas supply pipe 207, a plurality of fuel gas supply branch pipes 207a, a fuel gas discharge pipe 209, and a plurality of fuel gas discharge branch pipes 209a. The SOFC module 201 includes an oxidizing gas supply pipe (not illustrated), an oxidizing gas supply branch pipe (not illustrated), an oxidizing gas discharge pipe (not illustrated), and a plurality of oxidizing gas discharge branch pipes (not illustrated).

The fuel gas supply pipe 207 is provided on the outside of the pressure vessel 205, connected to a fuel gas supply unit for supplying fuel gas having a predetermined gas composition and predetermined flow rate in accordance with the power generation amount of the SOFC module 201, and connected to the plurality of fuel gas supply branch pipes 207a. The fuel gas supply pipe 207 branches the predetermined flow rate of fuel gas supplied from the above-described fuel gas supply unit to the plurality of fuel gas supply branch pipes 207a, and guides the fuel gas. The fuel gas supply branch pipe 207a is connected to the fuel gas supply pipe 207 and is connected to the plurality of SOFC cartridges 203. The fuel gas supply branch pipe 207a guides the fuel gas supplied from the fuel gas supply pipe 207 to the plurality of SOFC cartridges 203 at substantially uniform flow rate, and makes the power generation performance of the plurality of SOFC cartridges 203 substantially uniform.

The fuel gas discharge branch pipe 209a is connected to the plurality of SOFC cartridges 203 and to the fuel gas discharge pipe 209. The fuel gas discharge branch pipe 209a guides the exhaust fuel gas discharged from the SOFC cartridge 203 to the fuel gas discharge pipe 209. The fuel gas discharge pipe 209 is connected to the plurality of fuel gas discharge branch pipes 209a, and a part thereof is disposed on the outside of the pressure vessel 205. The fuel gas discharge pipe 209 guides the exhaust fuel gas derived from the fuel gas discharge branch pipe 209a at substantially equal flow rate to the outside of the pressure vessel 205.

Since the pressure vessel 205 is operated at internal pressure of 0.1 MPa to approximately 3 MPa and at internal temperature of the atmospheric temperature to approximately 550° C., material that maintains pressure tolerance and corrosion resistance with respect to oxygen containing gas, such as oxygen contained in the oxidizing gas, is used. For example, stainless steel material such as SUS304 is suitable.

Here, in the present embodiment, aspect in which the plurality of SOFC cartridges 203 are assembled and stored in the pressure vessel 205 is described, but the present invention is not limited thereto, and aspect in which the SOFC cartridges 203 are not assembled and stored in the pressure vessel 205 can also be employed.

As illustrated in FIG. 3, the SOFC cartridge 203 includes a plurality of cell stacks 101, a power generation chamber 215, a fuel gas supply header 217, a fuel gas discharge header 219, an oxidizing gas (air) supply header 221, and an oxidizing gas discharge header 223. The SOFC cartridge 203 includes an upper tube plate 225a, a lower tube plate 225b, an upper thermal insulation 227a, and a lower thermal insulation 227b. In the present embodiment, the SOFC cartridge 203 has a structure in which the fuel gas supply header 217, the fuel gas discharge header 219, the oxidizing gas supply header 221, and the oxidizing gas discharge header 223 are arranged as illustrated in FIG. 3 such that the fuel gas and the oxidizing gas flow while facing the inner side and the outer side of the cell stack 101, but this structure is not necessary, and, for example, the gas may flow while being parallel to the inner side and the outer side of the cell stack 101, and the oxidizing gas may flow in a cross flow to an axial direction of the cell stack 101.

The power generation chamber 215 is a region formed between the upper thermal insulation 227a and the lower thermal insulation 227b. The power generation chamber 215 is a region where the fuel cells 105 of the cell stack 101 are arranged, and is a region where power is generated by electrochemically reacting the fuel gas and the oxidizing gas. The temperature in the vicinity of center portion of the power generation chamber 215 in the longitudinal direction of the cell stack 101 is monitored by a temperature measurement unit (temperature sensor, thermocouple, or the like), and high temperature atmosphere of approximately 700° C. to 1000° C. is achieved during the steady operation of the SOFC module 201.

The fuel gas supply header 217 is a region surrounded by an upper casing 229a and an upper tube plate 225a of the SOFC cartridge 203, and is connected to the fuel gas supply branch pipe 207a through a fuel gas supply hole 231a provided in upper portion of the upper casing 229a. The plurality of cell stacks 101 are joined to the upper tube plate 225a by a seal member 237a, and the fuel gas supply header 217 guides the fuel gas supplied from the fuel gas supply branch pipe 207a through the fuel gas supply hole 231a at substantially uniform flow rate on the inside of the substrate tube 103 of the plurality of cell stacks 101, and makes the power generation performance of the plurality of cell stacks 101 substantially uniform.

The fuel gas discharge header 219 is a region surrounded by a lower casing 229b and the lower tube plate 225b of the SOFC cartridge 203, and is connected to the fuel gas discharge branch pipe 209a (not illustrated) through a fuel gas discharging hole 231b provided in the lower casing 229b. The plurality of cell stacks 101 are joined to the lower tube plate 225b by a seal member 237b, and the fuel gas discharge header 219 collects the exhaust fuel gas that passes through the inside of the substrate tube 103 of the plurality of cell stacks 101 and that is supplied to the fuel gas discharge header 219, and guides the exhaust fuel gas to the fuel gas discharge branch pipe 209a through the fuel gas discharging hole 231b.

Oxidizing gas having predetermined gas composition and predetermined flow rate is branched into the oxidizing gas supply branch pipe in accordance with the power generation amount of the SOFC module 201 and is supplied to a plurality of SOFC cartridges 203. The oxidizing gas supply header 221 is a region surrounded by the lower casing 229b, the lower tube plate 225b, and the lower thermal insulation 227b of the SOFC cartridge 203, and is connected to the oxidizing gas supply branch pipe (not illustrated) through an oxidizing gas supply hole 233a provided on side surface of the lower casing 229b. The oxidizing gas supply header 221 guides predetermined flow rate of oxidizing gas supplied from the oxidizing gas supply branch pipe (not illustrated) through the oxidizing gas supply hole 233a, to the power generation chamber 215 through an oxidizing gas supply gap 235a which will be described later.

The oxidizing gas discharge header 223 is a region surrounded by the upper casing 229a, the upper tube plate 225a, and the upper thermal insulation 227a of the SOFC cartridge 203, and is connected to an oxidizing gas discharge branch pipe (not illustrated) through an oxidizing gas discharging hole 233b provided on the side surface of the upper casing 229a. The oxidizing gas discharge header 223 guides the exhaust oxidizing gas supplied from the power generation chamber 215 to the oxidizing gas discharge header 223 through an oxidizing gas discharge gap 235b which will be described later, to the oxidizing gas discharge branch pipe (not illustrated) through the oxidizing gas discharging hole 233b.

The upper tube plate 225a is fixed to the side plate of the upper casing 229a such that the upper tube plate 225a, the top plate of the upper casing 229a, and the upper thermal insulation 227a are substantially parallel to each other, between the top plate of the upper casing 229a and the upper thermal insulation 227a. The upper tube plate 225a has a plurality of holes corresponding to the number of cell stacks 101 provided in the SOFC cartridge 203, and the cell stacks 101 are respectively inserted into the holes. The upper tube plate 225a airtightly supports one end portion of the plurality of cell stacks 101 via one or both of the seal member 237a and an adhesive member, and further isolates the fuel gas supply header 217 and the oxidizing gas discharge header 223 from each other.

The upper thermal insulation 227a is disposed at lower end portion of the upper casing 229a such that the upper thermal insulation 227a, the top plate of the upper casing 229a, and the upper tube plate 225a are substantially parallel to each other, and is fixed to the side plate of the upper casing 229a. The upper thermal insulation 227a has a plurality of holes corresponding to the number of cell stacks 101 provided in the SOFC cartridge 203. The diameter of the hole is set to be higher than the outer diameter of the cell stack 101. The upper thermal insulation 227a includes an oxidizing gas discharge gap 235b formed between the inner surface of the hole and the outer surface of the cell stack 101 inserted into the upper thermal insulation 227a.

The upper thermal insulation 227a separates the power generation chamber 215 and the oxidizing gas discharge header 223 from each other, the temperature increase of the atmosphere around the upper tube plate 225a, which causes the strength deterioration or increase in corrosion due to the oxygen containing gas contained in the oxidizing gas, is suppressed. The upper tube plate 225a and the like are made of high temperature durable metallic material such as Inconel to prevent thermal deformation since the upper tube plate 225a and the like are exposed to the high temperature in the power generation chamber 215, and the temperature difference in the upper tube plate 225a and the like increases. The upper thermal insulation 227a guides the exhaust oxidizing gas that has passed through the power generation chamber 215 and that has been exposed to the high temperature, to the oxidizing gas discharge header 223 through the oxidizing gas discharge gap 235b.

According to the present embodiment, due to the structure of the above-described SOFC cartridge 203, the fuel gas and the oxidizing gas flow while facing the inner side and the outer side of the cell stack 101. Accordingly, the exhaust oxidizing gas exchanges heat with the fuel gas supplied to the power generation chamber 215 through the inside of the substrate tube 103, is cooled to temperature at which deformation such as buckling of the upper tube plate 225a and the like made of metallic material does not occur, and is supplied to the oxidizing gas discharge header 223. The temperature of the fuel gas increases via the heat exchange with the exhaust oxidizing gas discharged from the power generation chamber 215, and the fuel gas is supplied to the power generation chamber 215. As a result, it is possible to supply the fuel gas preheated to temperature suitable for power generation without using a heater or the like, to the power generation chamber 215.

The lower tube plate 225b is fixed to the side plate of the lower casing 229b such that the lower tube plate 225b, the bottom plate of the lower casing 229b, and the lower thermal insulation 227b are substantially parallel to each other, between the bottom plate of the lower casing 229b and the lower thermal insulation 227b. The lower tube plate 225b has a plurality of holes corresponding to the number of cell stacks 101 provided in the SOFC cartridge 203, and the cell stacks 101 are respectively inserted into the holes. The lower tube plate 225b airtightly supports the other end portion of the plurality of cell stacks 101 via one or both of the seal member 237b and an adhesive member, and further isolates the fuel gas discharge header 219 and the oxidizing gas supply header 221 from each other.

The lower thermal insulation 227b is disposed at upper end portion of the lower casing 229b such that the lower thermal insulation 227b, the bottom plate of the lower casing 229b, and the lower tube plate 225b are substantially parallel to each other, and is fixed to the side plate of the lower casing 229b. The lower thermal insulation 227b has a plurality of holes corresponding to the number of cell stacks 101 provided in the SOFC cartridge 203. The diameter of the hole is set to be higher than the outer diameter of the cell stack 101. The lower thermal insulation 227b includes the oxidizing gas supply gap 235a formed between the inner surface of the hole and the outer surface of the cell stack 101 inserted into the lower thermal insulation 227b.

The lower thermal insulation 227b separates the power generation chamber 215 and the oxidizing gas supply header 221 from each other, the temperature of the atmosphere around the lower tube plate 225b increases, and the strength deterioration or increase in corrosion due to the oxygen containing gas contained in the oxidizing gas is suppressed. The lower tube plate 225b and the like are made of high temperature durable metallic material such as Inconel, but thermal deformation is prevented since the lower tube plate 225b and the like are exposed to the high temperature, and the temperature difference in the lower tube plate 225b and the like increases. The lower thermal insulation 227b guides the oxidizing gas supplied to the oxidizing gas supply header 221 to the power generation chamber 215 through the oxidizing gas supply gap 235a.

According to the present embodiment, due to the structure of the above-described SOFC cartridge 203, the fuel gas and the oxidizing gas flow while facing the inner side and the outer side of the cell stack 101. Accordingly, the exhaust fuel gas that has passed through the power generation chamber 215 exchanges heat with the oxidizing gas supplied to the power generation chamber 215 through the inside of the substrate tube 103, is cooled to temperature at which deformation such as buckling of the lower tube plate 225b and the like made of metallic material does not occur, and is supplied to the fuel gas discharge header 219. The temperature of the oxidizing gas increases via the heat exchange with the exhaust fuel gas, and the fuel gas is supplied to the power generation chamber 215. As a result, it is possible to supply the oxidizing gas of which the temperature has increased to temperature necessary for power generation without using a heater or the like, to the power generation chamber 215.

After the DC power generated in the power generation chamber 215 is conducted to the vicinity of the end portion of the cell stack 101 by the lead film 115 made of Ni/YSZ or the like provided in the plurality of fuel cells 105, the DC power is collected on a current collecting rod (not illustrated) of the SOFC cartridge 203 through a current collecting plate (not illustrated), and is taken out to the outside of each of the SOFC cartridges 203. The DC power conducted to the outside of the SOFC cartridge 203 by the current collecting rod connects the generated power of each SOFC cartridge 203 to predetermined serial number and parallel number, is conducted to the outside of the SOFC module 201, converted to predetermined AC power via a power conversion device (such as an inverter), a power conditioner and the like (not illustrated), and is supplied to a power consumer (for example, electric load equipment or a power grid).

A schematic configuration of fuel cell system 310 according to embodiment of the present disclosure will be described.

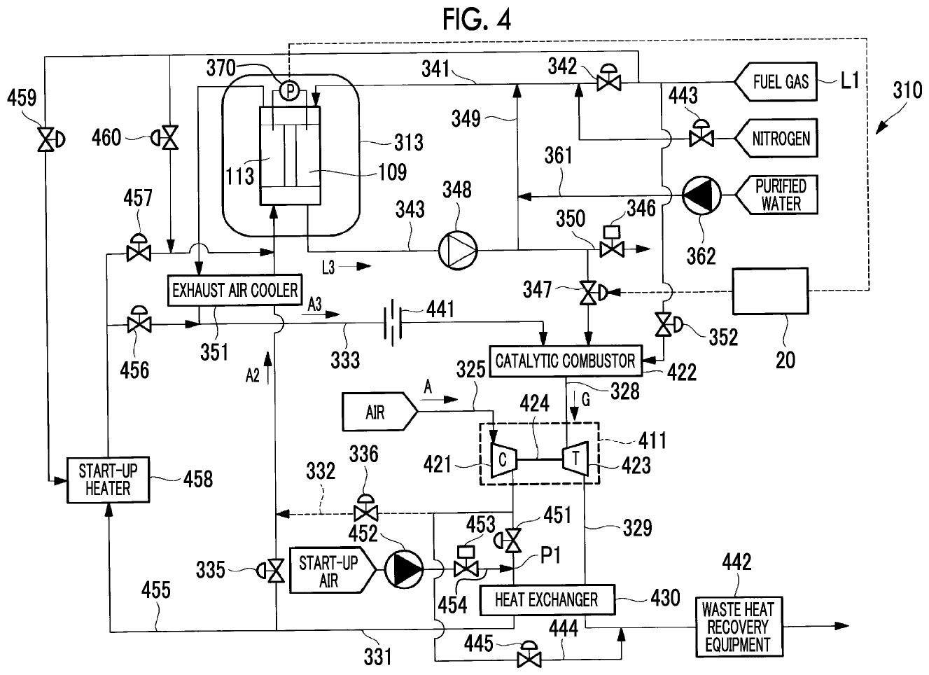

FIG. 4 shows a schematic configuration of the fuel cell system 310 according to the embodiment of the present disclosure. As illustrated in FIG. 4, the fuel cell system 310 includes a turbocharger 411 and SOFC 313. The SOFC 313 is configured by combining one or a plurality of SOFC modules (not illustrated), and is hereinafter simply referred to as “SOFC”. The fuel cell system 310 uses the SOFC 313 to generate power. The fuel cell system 310 is controlled by the control unit 20.

The turbocharger 411 includes a compressor 421 and a turbine 423, and the compressor 421 and the turbine 423 are connected to each other by a rotary shaft 424 so as to be integrally rotatable. The compressor 421 is rotationally driven by rotation of the turbine 423 which will be described later. The present embodiment is example in which air is used as the oxidizing gas, and the compressor 421 compresses air A taken in from air intake line 325.

The air A is taken into the compressor 421 that configures the turbocharger 411 and is compressed, and the compressed air A is supplied as oxidizing gas A2 to the cathode 113 of the SOFC. Exhaust oxidizing gas A3 after being used in the chemical reaction for power generation in the SOFC is sent to a catalytic combustor (combustor) 422 via exhaust oxidizing gas line 333, exhaust fuel gas L3 used in the chemical reaction for power generation in the SOFC is boosted by a recycling blower 348, and a part of the exhaust fuel gas L3 is recycled and supplied to fuel gas line 341 via fuel gas recycling line 349, and the other part is sent to the catalytic combustor 422 via exhaust fuel gas line 343.

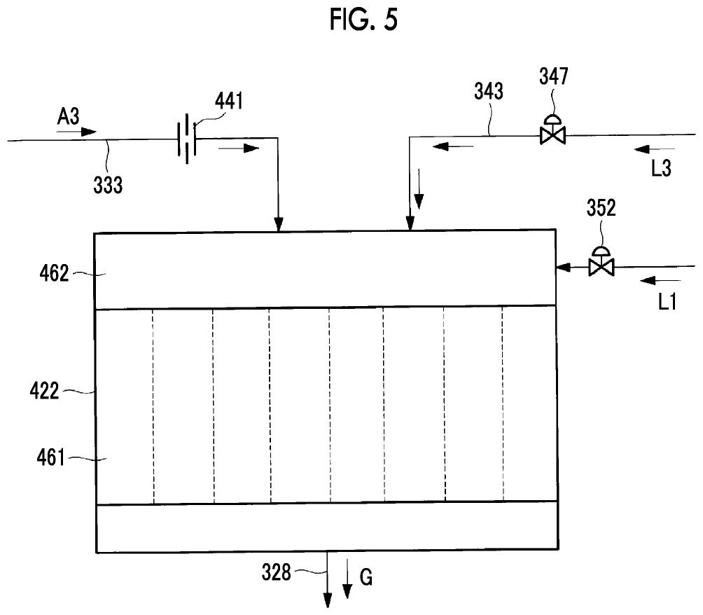

In this manner, a part of the exhaust fuel gas L3 and the exhaust oxidizing gas A3 is supplied to the catalytic combustor 422, and stably performs combustion even at relatively low temperature using a combustion catalyst in a catalytic combustion unit 461 (described below) to produce combustion gas G. At this time, the catalytic combustor 422 is provided with a pressure equalizing unit (hereinafter, referred to as “pressure equalizing space”) 462 as illustrated in FIG. 5. The pressure equalizing space 462 is a region for equalizing the pressure of the exhaust oxidizing gas A3 and of the exhaust fuel gas in a common space, and is also a region for mixing the gases. In other words, in the pressure equalizing space 462, the pressures of the exhaust oxidizing gas A3 supplied to the catalytic combustor 422 and of the exhaust fuel gas become the same, and the pressure is equalized. In other words, the outlet pressures of the exhaust oxidizing gas line 333 and of the exhaust fuel gas line 343 are equalized. When the pressure can be equalized, the pressure equalizing space 462 is not limited to be located adjacent to the catalytic combustor 422.

The catalytic combustor 422 mixes the exhaust fuel gas L3, the exhaust oxidizing gas A3, and fuel gas L1 if necessary, and combusts the mixed gas in the catalytic combustion unit 461 to produce the combustion gas G. The catalytic combustion unit 461 is filled with a combustion catalyst containing, for example, platinum or palladium as a main catalytic component, and stable combustion is possible at relatively low temperature and at a low oxygen concentration. The exhaust fuel gas L3, the exhaust oxidizing gas A3, and, when necessary, the fuel gas L1 are mixed in the pressure equalizing space 462. The combustion gas G is supplied to the turbine 423 through combustion gas supply line 328. The turbine 423 is rotationally driven by the adiabatic expansion of the combustion gas G, and the combustion gas G is discharged from combustion exhaust gas line 329.

The fuel gas L1 is supplied to the catalytic combustor 422 by controlling the flow rate with a control valve 352. The fuel gas L1 is combustible gas, and, for example, gas obtained by vaporizing liquefied natural gas (LNG) or natural gas, town gas, hydrogen (H₂), carbon monoxide (CO), hydrocarbon gases such as methane (CH₄), and gas produced by a gasification facility from carbonaceous raw materials (petroleum, coal, and the like) are used. The fuel gas means fuel gas of which calorific value has been regulated to be substantially constant in advance.

The combustion gas G of which the temperature has been raised by combustion in the catalytic combustor 422 is sent to the turbine 423 that configures the turbocharger 411 through the combustion gas supply line 328, and the turbine 423 is rotationally driven to generate rotational power. By driving the compressor 421 with this rotational power, the air A taken in from the air intake line 325 is compressed to generate compressed air. Since the power of the rotating device that compresses and blows the oxidizing gas (air) can be produced by the turbocharger 411, the required additional power can be reduced, and the power generation efficiency of the power generation system can be improved.

A heat exchanger (regenerative heat exchanger) 430 exchanges heat between the exhaust gas discharged from the turbine 423 and the oxidizing gas A2 supplied from the compressor 421. The exhaust gas is cooled by heat exchange with the oxidizing gas A2, and then released to the outside through a chimney (not illustrated), for example, through waste heat recovery equipment 442.

The SOFC 313 generates power by reacting at predetermined operating temperature by supplying the fuel gas L1 as reducing agent and the oxidizing gas A2 as oxygen containing gas.

The SOFC 313 is constituted of an SOFC module (not illustrated) and accommodates an aggregate of the plurality of cell stacks provided in the pressure vessel of the SOFC module, and the anode 109, the cathode 113, and the solid electrolyte film 111 are provided in the cell stack (not illustrated).

The SOFC 313 generates power by supplying the oxidizing gas A2 to the cathode 113 and supplying the fuel gas L1 to the anode 109, converts the power to predetermined power via a power conversion device (such as an inverter) such as a power conditioner (not illustrated), and supplies the converted power to a power consumer.

The SOFC 313 is connected to oxidizing gas supply line 331 for supplying the oxidizing gas A2 compressed by the compressor 421 to the cathode 113. The oxidizing gas A2 is supplied to an oxidizing gas introduction unit (not illustrated) of the cathode 113 through the oxidizing gas supply line 331. The oxidizing gas supply line 331 is provided with a control valve 335 for regulating the flow rate of the oxidizing gas A2 to be supplied. In the heat exchanger 430, the oxidizing gas A2 exchanges heat with the combustion gas discharged from the combustion exhaust gas line 329, and the temperature thereof increases. Furthermore, heat exchanger bypass line 332 that bypasses the heat transfer part of the heat exchanger 430 is provided in the oxidizing gas supply line 331. A control valve 336 is provided in the heat exchanger bypass line 332 such that the bypass flow rate of the oxidizing gas can be regulated. By controlling the opening of the control valve 335 and the control valve 336, the flow ratio of the oxidizing gas passing through the heat exchanger 430 and the oxidizing gas bypassing the heat exchanger 430 is regulated, and the temperature of the oxidizing gas A2 to be supplied to the SOFC 313 is regulated. The temperature of the oxidizing gas A2 supplied to the SOFC 313 maintains temperature at which the fuel gas of the SOFC 313 and the oxidizing gas are electrochemically reacted to generate power, and the upper limit of temperature is limited so as not to damage the materials of each component on the inside of the SOFC module (not illustrated) that configures the SOFC 313.

The SOFC 313 is connected to the exhaust oxidizing gas line 333 for supplying the exhaust oxidizing gas A3 discharged after being used by the cathode 113 to the turbine 423 via the catalytic combustor 422. The exhaust oxidizing gas line 333 is provided with an exhaust air cooler 351. Specifically, in the exhaust oxidizing gas line 333, the exhaust air cooler 351 is provided on the upstream side of an orifice 441 described later, and the exhaust oxidizing gas A3 is cooled by heat exchange with the oxidizing gas A2 flowing through the oxidizing gas supply line 331.

The exhaust oxidizing gas line 333 is provided with a pressure loss unit. In the present embodiment, the orifice 441 is provided as a pressure loss unit. The orifice 441 adds pressure loss to the exhaust oxidizing gas A3 that flows through the exhaust oxidizing gas line 333. The pressure loss unit is not limited to the orifice 441, and a throttle such as a Venturi tube may be provided, and any means capable of adding pressure loss to the exhaust oxidizing gas A3 can be used. As the pressure loss unit, for example, an additional burner may be provided. The additional burner causes pressure loss in the exhaust oxidizing gas, and the additional fuel can be combusted when combustion exceeding the combustion capacity of the catalytic combustor 422 is required. Therefore, a sufficient amount of heat can be supplied to the exhaust oxidizing gas. In the fuel cell system 310, the pressure difference between the cathode 113 side and the anode 109 side is controlled by a regulating valve 347 provided in the exhaust fuel gas line 343 so as to be within predetermined range, and thus, by adding pressure loss to the exhaust oxidizing gas line 333 that merges with the exhaust fuel gas line 343, it is possible to ensure the operating differential pressure required for stable control of the regulating valve 347 provided in the exhaust fuel gas line 343.

The exhaust oxidizing gas line 333 is not provided with vent system and a vent valve for releasing the exhaust oxidizing gas A3 to the atmosphere (outside the system). For example, in case of power generation system that combines the SOFC and the gas turbine (for example, a micro gas turbine) that combusts the exhaust oxidizing gas A3 discharged from the cathode 113 and the exhaust fuel gas L3 discharged from the anode 109, there is case where the pressure state of the oxidizing gas supplied to the cathode 113 changes according to the change in the state of the micro gas turbine at the time of start-up or stop, and further, there is possibility that the differential pressure control between the anode 109 and the cathode 113 becomes unsuccessful because of sudden fluctuations in pressure. Therefore, in case where a trip occurs for some reason, the generator of the micro gas turbine becomes unloaded, and protection measures for the micro gas turbine are required. Therefore, vent system and a vent valve that release the exhaust oxidizing gas A3 to the outside of the system such as to the atmosphere are required. However, in the present embodiment, the turbocharger 411 is used, there is no generator communicating with the rotary shaft, and the load is not applied. Therefore, since there is no case where the load disappears during the trip, over-rotation occurs, and the pressure increases sharply, the differential pressure state can be stably controlled by the regulating valve 347, and thus, a mechanism (bent system and vent valve) for releasing the exhaust oxidizing gas A3 to the atmosphere can be omitted.

The SOFC 313 is further connected to the fuel gas line 341 for supplying the fuel gas L1 to a fuel gas introduction unit (not illustrated) of the anode 109, and to the exhaust fuel gas line 343 for supplying the exhaust fuel gas L3, which is discharged after being used for the reaction in the anode 109, to the turbine 423 via the catalytic combustor 422. The fuel gas line 341 is provided with a control valve 342 for regulating the flow rate of the fuel gas L1 supplied to the anode 109.

As illustrated in FIG. 4, the fuel cell system 310 includes a differential pressure sensor 370 that measures the differential pressure between the anode 109 and the cathode 113. The information on the differential pressure value between the anode 109 and the cathode 113 measured by the differential pressure sensor 370 is sent to the control unit 20. A pressure sensor may be provided in each line of the cathode 113 and the anode 109, and each of the pressure of the cathode 113 and the pressure of the anode 109 with the differential pressure calculated by those measured values, may be acceptable. The pressure measurement positions in FIG. 4 are schematically illustrated, and each pressure measurement position is not limited to the positions in FIG. 4.

The recycling blower 348 is provided in the exhaust fuel gas line 343. The exhaust fuel gas line 343 is provided with the regulating valve 347 for regulating the flow rate of a part of the exhaust fuel gas L3 supplied to the catalytic combustor 422. In other words, the regulating valve 347 regulates the pressure state of the exhaust fuel gas L3. Therefore, as will be described later, the differential pressure between the anode 109 and the cathode 113 can be regulated by controlling the regulating valve 347 with the control unit 20.

Exhaust fuel gas release line 350 that releases the exhaust fuel gas L3 to the atmosphere (outside the system) is connected to the exhaust fuel gas line 343 on the downstream side of the recycling blower 348. A shutoff valve (fuel vent valve) 346 is provided on the exhaust fuel gas release line 350. In other words, by opening the shutoff valve 346, a part of the exhaust fuel gas L3 of the exhaust fuel gas line 343 can be released from the exhaust fuel gas release line 350. By discharging the exhaust fuel gas L3 to the outside of the system, the excess pressure can be quickly regulated. In the exhaust fuel gas line 343, the fuel gas recycling line 349 for recycling the exhaust fuel gas L3 to the fuel gas introduction unit of the anode 109 of the SOFC 313 is connected to the fuel gas line 341.

Furthermore, the fuel gas recycling line 349 is provided with purified water supply line 361 for supplying purified water for reforming the fuel gas L1 at the anode 109. The purified water supply line 361 is provided with a pump 362. By controlling the discharge flow rate of the pump 362, the amount of purified water supplied to the anode 109 is regulated. Since water vapor is generated at the anode during power generation, the exhaust fuel gas L3 of the exhaust fuel gas line 343 contains water vapor. Therefore, the water vapor is recycled and supplied by the fuel gas recycling line 349, and accordingly, the flow rate of purified water supplied by the purified water supply line 361 can be decreased or cut off.

Next, a configuration for releasing the oxidizing gas discharged from the compressor 421 will be described. Specifically, in the oxidizing gas supply line 331 on the downstream side of the compressor 421, oxidizing gas blow line 444 is provided such that the oxidizing gas can flow so as to bypass the heat exchanger 430 and be released. One end of the oxidizing gas blow line 444 is connected to the upstream side of the heat exchanger 430 of the oxidizing gas supply line 331, and the other end is connected to the downstream side of the heat exchanger 430 of the combustion exhaust gas line 329 which is the downstream side of the turbine 423. A release valve (air extraction blow valve) 445 is provided on the oxidizing gas blow line 444. In other words, by opening the release valve 445, a part of the oxidizing gas discharged from the compressor 421 is released to the atmosphere outside the system through the chimney (not illustrated) via the oxidizing gas blow line 444.

Next, the configuration used for starting the fuel cell system 310 will be described. The oxidizing gas supply line 331 is provided with a control valve 451 on the downstream side of the connection point with the oxidizing gas blow line 444, and the downstream side (upstream side of the heat exchanger 430) of the control valve 451 is connected to start-up air supply line 454 having a blower 452 for supplying the start-up air and a control valve 453. When performing the start-up of the fuel cell system 310, while the blower 452 supplies the start-up air to the oxidizing gas supply line 331, the control valve 451 and the control valve 453 switch to the oxidizing gas from the compressor 421. In the oxidizing gas supply line 331, start-up air heating line 455 is connected to the downstream side (upstream side of the control valve 335) of the heat exchanger 430, is connected to the exhaust oxidizing gas line 333 on the downstream side of the exhaust air cooler 351 via the control valve 456, and is connected to the oxidizing gas supply line 331 (inlet side of the cathode 113) via a control valve 457. The start-up air heating line 455 is provided with a start-up heater 458, and the fuel gas L1 is supplied via a control valve 459 to heat the oxidizing gas flowing through the start-up air heating line 455.

The control valve 457 regulates the flow rate of the oxidizing gas supplied to the start-up heater 458, and controls the temperature of the oxidizing gas supplied to the SOFC 313.

The fuel gas L1 is also supplied to the cathode 113 via a control valve 460. The control valve 460 controls, for example, the flow rate of the fuel gas L1 supplied to the cathode 113 when the fuel gas L1 is supplied to the cathode 113 from the downstream side of the control valve 457 in the start-up air heating line 455 when the SOFC 313 is started, and the temperature of the power generation chamber is raised by catalytic combustion.

The control unit 20 performs control in the fuel cell system 310. In particular, the differential pressure control for the SOFC is performed.

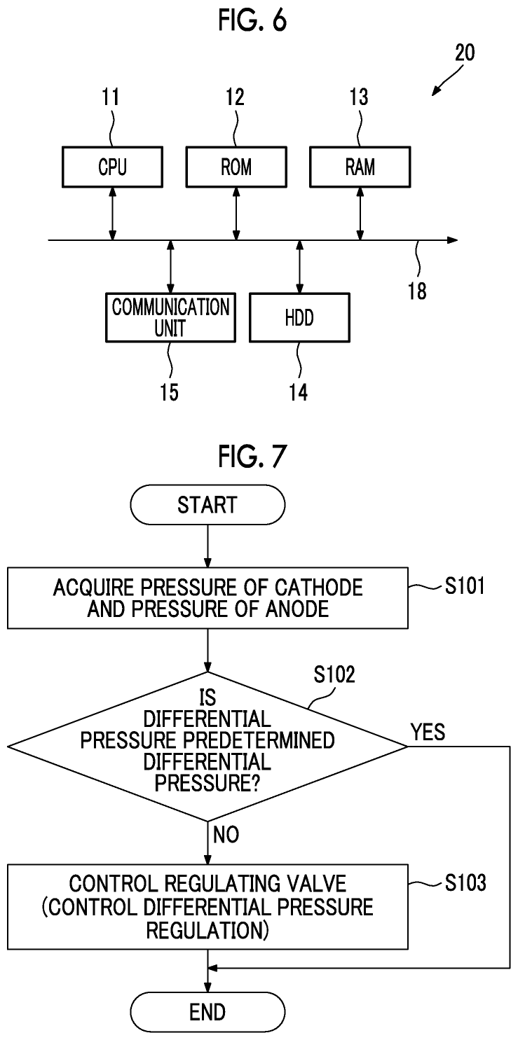

FIG. 6 shows example of a hardware configuration of the control unit 20 according to the present embodiment.

As illustrated in FIG. 6, the control unit 20 is computer system (computing system), and includes, for example, a CPU 11, a read only memory (ROM) 12 for storing a program or the like executed by the CPU 11, a random access memory (RAM) 13 that functions as a work region at the time of executing each program, a hard disk drive (HDD) 14 as a large-capacity storage device, and a communication unit 15 for connecting to a network or the like. As the large-capacity storage device, a solid state drive (SSD) may be used. Each of these parts is connected via a bus 18.

The control unit 20 may include an input unit including a keyboard, a mouse, and the like; and a display unit including a liquid crystal display device for displaying data.

The storage medium for storing the program or the like executed by the CPU 11 is not limited to the ROM 12. For example, the storage medium may be another auxiliary storage device such as a magnetic disk, a magneto-optical disk, or a semiconductor memory.

A series of processes for realizing various functions (will be described later) is stored in the hard disk drive 14 or the like in the form of a program, the CPU 11 reads the program into the RAM 13 or the like and executes information processing and arithmetic processing, and accordingly, various functions are realized. The program may be installed in advance in the ROM 12 or other storage medium, provided in state of being stored in a computer-readable storage medium, or delivered via wired or wireless communication means. The computer-readable storage medium is a magnetic disk, a magneto-optical disk, a CD-ROM, a DVD-ROM, a semiconductor memory, or the like.

The control unit 20 controls the regulating valve 347 to control the differential pressure between the pressure of the cathode 113 and the pressure of the anode 109 in the fuel cell. In the fuel cell, differential pressure state is preferable in which the pressure of the anode 109 is larger than the pressure of the cathode 113 by predetermined differential pressure (for example, 0.1 kPa or more and 1 kPa or less) during normal operation. Therefore, in the control unit 20, the regulating valve 347 controls the pressure on the anode 109 side to regulate the differential pressure between the pressure of the cathode 113 and the pressure of the anode 109. The pressure of the cathode 113 is the pressure of the oxidizing gas or of the exhaust oxidizing gas A3 flowing through the cathode line, for example, the pressure of the oxidizing gas in the SOFC module 201.

The pressure of the anode 109 is the pressure of the fuel gas L1 or of the exhaust fuel gas L3 flowing through the anode line, for example, the pressure of the fuel gas L1 in the SOFC module 201.

In the present embodiment, the exhaust fuel gas line 343 and the exhaust oxidizing gas line 333 are connected to the pressure equalizing space 462 of the catalytic combustor 422. In other words, the gas containing the fuel component discharged from the exhaust fuel gas line 343 and the gas containing the oxidizing gas component discharged from the exhaust oxidizing gas line 333 are connected to common space called the pressure equalizing space 462 and the pressure thereof is equalized, and the gases are mixed together. In other words, the pressure state of the exhaust fuel gas line 343 and of the exhaust oxidizing gas line 333 on the outlet side (pressure equalizing space 462 side) is equalized. Furthermore, since the orifice 441 is provided in the exhaust oxidizing gas line 333, constant pressure loss according to the flow rate of the exhaust oxidizing gas A3 flowing inside is added in the exhaust oxidizing gas line 333. Therefore, the pressure loss of the orifice 441 is added based on the pressure of the pressure equalizing space 462, and the pressure loss of the pipe to the outlet of the cathode 113, such as the exhaust oxidizing gas line 333, is added, and the pressure state on the cathode 113 side is determined. Meanwhile, the anode 109 is connected to the pressure equalizing space 462 via the regulating valve 347 in the exhaust fuel gas line 343. Therefore, based on the pressure in the pressure equalizing space 462, pressure loss due to the regulation of the opening of the regulating valve 347 is added, and further, pressure loss of the pipe to the outlet of the anode 109, such as the exhaust fuel gas line 343, is added, and the pressure state on the anode 109 side is determined. In other words, the pressure on the anode 109 side can be regulated by regulating the pressure loss accompanying the regulation of the opening of the regulating valve 347. In this manner, by using the pressure equalizing space 462 and the orifice 441, the pressure loss of the orifice 441 is added to the exhaust oxidizing gas based on the pressure in the pressure equalizing space 462, and accordingly, pressure difference sufficient to enable effective and stable control of pressure regulation by the regulating valve 347 provided in the exhaust fuel gas line 343 can be obtained.

In the present embodiment, case where the differential pressure can be effectively controlled by the regulating valve 347 using the regulating valve 347, the pressure equalizing space 462, and the orifice 441 will be described, but either one of the pressure equalizing space 462 and the orifice 441 can control the differential pressure by the regulating valve 347. When the operating differential pressure for pressure regulation by the regulating valve 347 of the exhaust fuel gas line 343 can be ensured without installing the orifice (pressure loss unit) 441, only the regulating valve 347 can be provided to control the differential pressure.

The control unit 20 acquires the pressure on the cathode 113 side and the pressure on the anode 109 side. Then, the difference between the pressure of the cathode 113 and the pressure of the anode 109 is used as the differential pressure, and the opening of the regulating valve 347 is controlled such that the differential pressure becomes predetermined differential pressure. The pressure of the cathode 113 and the pressure of the anode 109 may be acquired individually, or the differential pressure may be acquired by using the differential pressure sensor 370. In the present embodiment, the differential pressure is value obtained by subtracting the pressure of the cathode 113 from the pressure of the anode 109. In other words, in case where the pressure is higher on the anode 109 side, the differential pressure is positive value, and in case where the pressure is higher on the cathode 113 side, the differential pressure is negative value. For example, in case where the pressure of the anode 109 is higher than the predetermined differential pressure with respect to the pressure of the cathode 113, control is performed in the direction of opening the opening of the regulating valve 347 such that the pressure of the anode 109 decreases.

In this manner, the differential pressure state is effectively regulated by controlling the regulating valve 347.

In case where an abnormality occurs in the differential pressure state, the control unit 20 performs abnormality response control. The abnormal state is case where the pressure difference of the anode 109 against the cathode 113 is higher than the predetermined value. The predetermined value is set as lower limit value that is assumed to be in abnormal state in case where the anode 109 is higher than the cathode 113. In the present embodiment, for example, predetermined value is set in range of differential pressure of 1 kPa or more and 50 kPa or less.

Specifically, in case where the pressure difference of the anode 109 against the cathode 113 becomes higher than the predetermined value, the control unit 20 opens the shutoff valve 346 provided in the exhaust fuel gas release line 350. Accordingly, a part of the exhaust fuel gas discharged from the anode 109 can be released to the atmosphere to quickly decrease the pressure on the anode 109 side. Therefore, it is possible to prevent the case where the differential pressure state becomes abnormal state and continues, and to return to the stable state.

The abnormal state may be case where the cathode 113 is higher than a predetermined value with respect to the anode 109. In such case, the predetermined value is set as lower limit value that is assumed to be abnormal state in case where the cathode 113 is higher than the anode 109. In the present embodiment, for example, predetermined value is set in range of differential pressure of −50 kPa or more and −1 kPa or less.

Specifically, in case where the pressure of the cathode 113 against the pressure of the anode 109 becomes higher than a predetermined value, the control unit 20 opens the release valve 445 provided in the oxidizing gas blow line 444. Accordingly, the amount of oxidizing gas supplied to the cathode 113 can be reduced, and the pressure of the cathode 113 can be quickly lowered. Therefore, it is possible to prevent case where the differential pressure state becomes abnormal state and continues, and to return to the stable state.

Next, example of differential pressure control by the above-described control unit 20 will be described with reference to FIG. 7. FIG. 7 is a flowchart illustrating example of procedure of the differential pressure control according to the present embodiment. The flow illustrated in FIG. 7 is repeatedly executed, for example, at predetermined control cycle.

First, the pressure of the cathode 113 and the pressure of the anode 109 are acquired, and the differential pressure is confirmed. Otherwise, the differential pressure between the anode 109 and the cathode 113 may be acquired (S101).

Next, it is determined whether or not the differential pressure is predetermined differential pressure (S102). In S102, the target differential pressure may be set as predetermined differential pressure range (including predetermined differential pressure), and it may be determined whether or not the differential pressure is within the predetermined differential pressure range.

In case where the differential pressure is predetermined differential pressure (YES determination in S102), the process ends.

In case where the differential pressure is not predetermined differential pressure (NO determination in S102), the opening of the regulating valve 347 is controlled to execute the differential pressure regulation control (S103).

In this manner, the differential pressure state between the anode 109 and the cathode 113 is maintained at appropriate value.

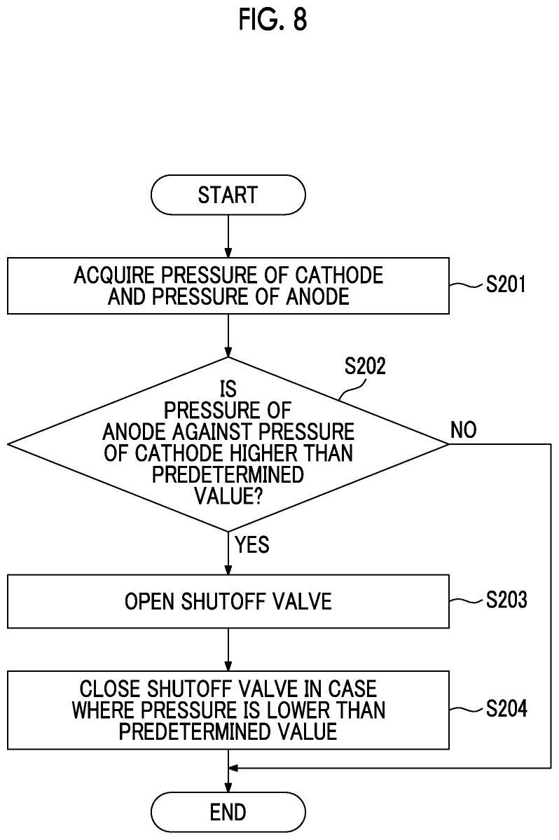

Next, example of an abnormality process by the above-described control unit 20 will be described with reference to FIG. 8. FIG. 8 shows example of a flowchart of procedure to deal with the abnormal process according to the present embodiment. The flow illustrated in FIG. 8 is repeatedly executed, for example, at predetermined control cycle.

First, the pressure of the cathode 113 and the pressure of the anode 109 are acquired (S201). Otherwise, the differential pressure between the anode 109 and the cathode 113 may be acquired.

It is determined whether or not the pressure on the anode 109 side is higher than predetermined value with respect to the cathode 113 (S202).

In case where the pressure on the anode 109 side is not higher than predetermined value with respect to the cathode 113 (NO determination in S202), the process ends.

In case where the pressure on the anode 109 side is higher than the predetermined value with respect to the cathode 113 (YES determination in S202), the shutoff valve (fuel vent valve) 346 provided in the exhaust fuel gas release line 350 is opened (S203). In this manner, immediate atmospheric release control of the fuel gas is performed.

In case where the pressure on the anode 109 side is less than predetermined value with respect to the cathode 113, the shutoff valve (fuel vent valve) 346 is closed (S204).

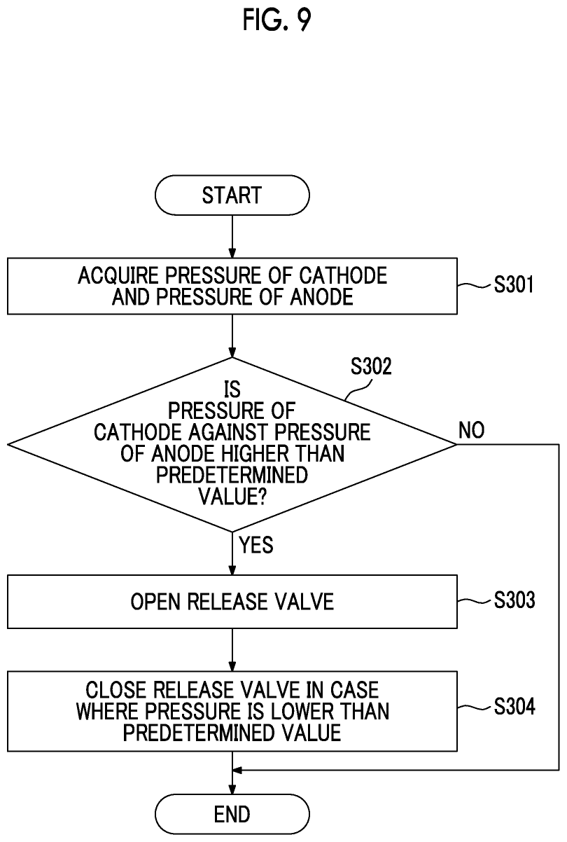

Next, example of the abnormality process by the above-described control unit 20 will be described with reference to FIG. 9. FIG. 9 shows example of flowchart of procedure of the abnormality process according to the present embodiment. The flow illustrated in FIG. 9 is repeatedly executed, for example, at predetermined control cycle.

First, the pressure of the cathode 113 and the pressure of the anode 109 are acquired (S301). Otherwise, the differential pressure between the anode 109 and the cathode 113 may be acquired.

It is determined whether or not the pressure on the cathode 113 side is higher than predetermined value with respect to the anode 109 (S302).

In case where the pressure on the cathode 113 side is not higher than predetermined value with respect to the anode 109 (NO determination in S302), the process ends.

In case where the pressure on the cathode 113 side is higher than predetermined value with respect to the anode 109 (YES determination in S302), the release valve (air extraction blow valve) 445 provided in the oxidizing gas blow line 444 is opened (S303). In this manner, the immediate atmospheric release control of the oxidizing gas is performed.

In case where the pressure on the cathode 113 side is less than predetermined value with respect to the anode 109, the release valve (air extraction blow valve) 445 is closed (S304).

As described above, according to the fuel cell system and the control method therefor according to the present embodiment, in case where the exhaust fuel gas discharged from the fuel cell and the oxidizing gas discharged from the fuel cell are supplied to the turbocharger 411, by controlling the regulating valve 347 provided in the exhaust fuel gas line 343 to control the differential pressure between the pressure of the cathode 113 and the pressure of the anode 109 in the fuel cell, the pressure difference between the cathode 113 and the anode 109 in the fuel cell can be properly regulated.

In case of applying the present disclosure to power generation system that combines the fuel cell and the gas turbine (for example, a micro gas turbine), the pressure state of the oxidizing gas supplied to the cathode 113 changes according to the change in the state of the micro gas turbine at the time of start-up or stop, and thus, there is possibility that the differential pressure control between the anode 109 and the cathode 113 becomes unsuccessful because of sudden fluctuations in pressure. Therefore, in case where trip occurs for some reason, the generator of the micro gas turbine becomes unloaded, and protection measures for the micro gas turbine are required. Therefore, it is necessary to provide vent system and a vent valve for releasing the oxidizing gas to the atmosphere (outside the system) through the exhaust oxidizing gas line 333, but when the turbocharger 411 is applied to the fuel cell and the differential pressure is regulated by the regulating valve 347, it becomes possible to eliminate the need for the vent system and the vent valve that releases the oxidizing gas to the atmosphere. Therefore, it is possible to simplify the configuration and to decrease the cost.

By providing the pressure equalizing space 462 which is connected to the exhaust fuel gas line 343 and to the exhaust oxidizing gas line 333 and which mixes the exhaust fuel gas and the oxidizing gas to equalize the pressure, the pressure state of the outlet of the exhaust oxidizing gas line 333 and of the outlet of the exhaust fuel gas line 343 can be easily equalized. Therefore, the pressure difference between the anode 109 and the cathode 113 can be controlled more efficiently by the regulating valve 347.

The exhaust fuel gas release line 350 that releases the exhaust fuel gas to the atmosphere is provided on the exhaust fuel gas line 343, the shutoff valve 346 is provided in the exhaust fuel gas release line 350, and accordingly, even in case of abnormal state where the pressure of the exhaust fuel gas in the exhaust fuel gas line 343 is higher than predetermined value, the exhaust fuel gas can be released to the atmosphere by the shutoff valve 346. In case where the pressure of the anode 109 against the pressure of the cathode 113 becomes higher than predetermined value, by opening the shutoff valve 346, the pressure of the anode 109 can be regulated by the shutoff valve 346, and the abnormal state can be suppressed.

In case where the oxidizing gas supply line 331 is provided with the oxidizing gas blow line 444 through which the oxidizing gas flows and the oxidizing gas blow line 444 is provided with the release valve 445, by opening the release valve 445 in case where the pressure of the cathode 113 against the pressure of the anode 109 becomes higher than predetermined value, it is possible to suppress abnormal state where the pressure of the cathode 113 against the pressure of the anode 109 becomes higher than the predetermined value.

The present disclosure is not limited to the above-described embodiments, and can be appropriately modified without departing from the gist of the present invention.

The fuel cell system and the control method therefor described in each of the above-described embodiments are understood as follows, for example.

Fuel cell system (310) according to the present disclosure includes fuel cell (313) having cathode (113) and anode (109); a turbocharger (411) having a turbine (423) and a compressor (421); exhaust fuel gas line (343) for supplying exhaust fuel gas (L3) discharged from the fuel cell (313) to a combustor (422); exhaust oxidizing gas line (333) for supplying exhaust oxidizing gas (A3) discharged from the fuel cell (313) to the combustor (422); combustion gas supply line (328) for supplying combustion gas (G) discharged from the combustor (422) to the turbine (423); oxidizing gas supply line (331) for supplying oxidizing gas (A2) compressed by the compressor (421) to the cathode (113) by rotationally driven by the turbine; a regulating valve (347) provided on the exhaust fuel gas line (343); and a control unit (20) that controls the regulating valve (347) to control differential pressure between pressure of the cathode (113) and pressure of the anode (109) in the fuel cell (313), in which vent system that releases the exhaust oxidizing gas (A3) to outside of the system is not provided on the exhaust oxidizing gas line (333).

According to the fuel cell system (310) relating to the present disclosure, in case where the exhaust fuel gas (L3) discharged from the fuel cell (313) and the oxidizing gas discharged from the fuel cell (313) are supplied to the turbocharger (411), by controlling the regulating valve (347) provided in the exhaust fuel gas line (343) to control the differential pressure between the pressure of the cathode (113) and the pressure of the anode (109) in the fuel cell (313), the pressure difference between the anode (109) and the cathode (113) in the fuel cell (313) can be properly regulated.

In case of applying the present disclosure to power generation system that combines the fuel cell (313) and the gas turbine (411) (for example, a micro gas turbine (411)), the pressure state of the oxidizing gas supplied to the cathode (113) changes according to the change in the state of the micro gas turbine at the time of start-up or stop of the micro gas turbine (411), and thus, there is possibility that the differential pressure control between the anode 109 and of the cathode 113 becomes unsuccessful because of sudden fluctuations in pressure. Therefore, in case where trip occurs for some reason, the generator of the micro gas turbine becomes unloaded, and protection measures for the micro gas turbine are required. Therefore, it is necessary to provide a vent valve on the vent line for releasing the oxidizing gas to the atmosphere through the exhaust oxidizing gas line (333), but when the turbocharger (411) is applied to the fuel cell (313) and the differential pressure is regulated by the regulating valve (347), it becomes possible to eliminate the need for the vent valve of the vent system that releases the oxidizing gas to the atmosphere. Therefore, it is possible to simplify the configuration and to decrease the cost. The vent system releases the exhaust oxidizing gas to the outside of the system during operation.

The fuel cell system (310) according to the present disclosure may further include a pressure equalizing unit (462) that is connected to the exhaust fuel gas line (343) and to the exhaust oxidizing gas line (333), and that equalizes the pressures of the exhaust fuel gas (L3) and of the exhaust oxidizing gas (A3).

According to the fuel cell system (310) of the present disclosure, the exhaust fuel gas line (343) and the exhaust oxidizing gas line (333) are connected to common space portion, the pressure equalizing unit (462) that equalizes the pressures of the exhaust fuel gas (L3) and of the exhaust oxidizing gas is formed, and accordingly, the pressure state of the outlet of the exhaust fuel gas line (343) and of the outlet of the exhaust oxidizing gas line (333) can be easily equalized. Therefore, the pressure difference between the cathode (113) and the anode (109) can be controlled more efficiently by the regulating valve (347). Since the exhaust fuel gas (L3) and the exhaust oxidizing gas can also be mixed in the pressure equalizing unit (462), the fuel cell system is suitable for combustion.

In the fuel cell system (310) according to the present disclosure, the pressure equalizing unit (462) may be provided as common space to which the exhaust fuel gas and the exhaust oxidizing gas are supplied in the combustor (422).

According to the fuel cell system (310) according to the present disclosure, by providing a pressure equalizing unit as common space to which the exhaust fuel gas and the exhaust oxidizing gas are supplied in the combustor (422), the pressure of the exhaust fuel gas (L3) and of the oxidizing gas can be equalized, and the gases can be mixed with each other. Specifically, as the combustor, a catalytic combustor can be used.

In the fuel cell system (310) according to the present disclosure, the combustor (422) may mix the exhaust fuel gas (L3) and the exhaust oxidizing gas (A3) at the pressure equalizing unit (462) and combust the mixed gas at a catalytic combustion unit (461) using a combustion catalyst.

According to the fuel cell system (310) relating to the present disclosure, pressure equalization and catalytic combustion can be performed in the combustor.

In the fuel cell system (310) according to the present disclosure, a pressure loss unit (441) that is provided in the exhaust oxidizing gas line (333) and that adds pressure loss to the exhaust oxidizing gas (A3) may further be provided.

According to the fuel cell system (310) relating to the present disclosure, by providing a pressure loss unit (for example, an orifice) that adds pressure loss to the oxidizing gas in the exhaust oxidizing gas line (333), it is possible to perform differential pressure control more efficiently via the regulating valve (347).

In the fuel cell system (310) according to the present disclosure, exhaust fuel gas release line (350) that is connected to the exhaust fuel gas line (343) and that releases the exhaust fuel gas (L3) to the atmosphere; and a shutoff valve (346) provided on the exhaust fuel gas release line (350), may further be provided.

According to the fuel cell system (310) relating to the present disclosure, the exhaust fuel gas release line (350) that releases the fuel gas to the atmosphere is provided on the exhaust fuel gas line (343), the shutoff valve (346) is provided in the exhaust fuel gas release line (350), and accordingly, even in case of abnormal state where the pressure of the fuel gas in the exhaust fuel gas line (343) is higher than predetermined value, the exhaust fuel gas can be released to the atmosphere by the shutoff valve (346).

In the fuel cell system (310) according to the present disclosure, the control unit (20) may open the shutoff valve (346) in case where the pressure of the anode (109) against the pressure of the cathode (113) becomes higher than predetermined value.

According to the fuel cell system (310) relating to the present disclosure, in case where the pressure of the anode (109) against the pressure of the cathode (113) becomes higher than predetermined value, by opening the shutoff valve (346), the pressure of the anode (109) can be regulated by the shutoff valve (346), and the abnormal state can be suppressed.

In the fuel cell system (310) according to the present disclosure, blow line (444) connected to the oxidizing gas supply line (331) and through which the oxidizing gas (A2) flows; and a release valve (445) provided on the blow line (444), may further be provided, and the control unit (20) may open the release valve (445) in case where the pressure of the cathode (113) against the pressure of the anode (109) becomes higher than predetermined value.

According to the fuel cell system (310) relating to the present disclosure, in case where the oxidizing gas supply line (331) is provided with the oxidizing gas blow line (444) through which the oxidizing gas flows and the oxidizing gas blow line (444) is provided with the release valve (445), by opening the release valve (445) in case where the pressure of the cathode (113) against the pressure of the anode (109) becomes higher than predetermined value, it is possible to suppress abnormal state where the pressure of the cathode (113) against the pressure of the anode (109) becomes higher than the predetermined value.

Method for controlling fuel cell system (310) according to the present disclosure is method for controlling fuel cell system (310) including fuel cell (313) having cathode (113) and anode (109), a turbocharger (411) having a turbine (423) and a compressor (421), exhaust fuel gas line (343) for supplying exhaust fuel gas (L3) discharged from the fuel cell (313) to a combustor (422), exhaust oxidizing gas line (333) for supplying exhaust oxidizing gas (A3) discharged from the fuel cell (313) to the combustor (422), combustion gas supply line (328) for supplying combustion gas (G) discharged from the combustor (422) to the turbine (423), oxidizing gas supply line (331) for supplying oxidizing gas (A2) compressed by the compressor (421) to the cathode (113) by rotationally driven by the turbine, and a regulating valve (347) provided on the exhaust fuel gas line (343), in which vent system that releases the exhaust oxidizing gas (A3) to outside of the system is not provided on the exhaust oxidizing gas line (333), the method including: controlling the regulating valve (347) to control differential pressure between pressure of the cathode (113) and pressure of the anode (109) in the fuel cell (313).

### REFERENCE SIGNS LIST

11: CPU

12: ROM

13: RAM

14: hard disk drive

15: communication unit

18: bus

20: control unit

101: cell stack

103: substrate tube

105: fuel cell

107: interconnector

109: anode (fuel electrode)

111: solid electrolyte film

113: cathode (air electrode)

115: lead film

201: SOFC module

203: SOFC cartridge

205: pressure vessel

207: fuel gas supply pipe

207a: fuel gas supply branch pipe

209: fuel gas discharge pipe

209a: fuel gas discharge branch pipe

215: power generation chamber

217: fuel gas supply header

219: fuel gas discharge header

221: oxidizing gas supply header

223: oxidizing gas discharge header

225a: upper tube plate

225b: lower tube plate

227a: upper thermal insulation

227b: lower thermal insulation

229a: upper casing

229b: lower casing

231a: fuel gas supply hole

231b: fuel gas discharging hole

233a: oxidizing gas supply hole

233b: oxidizing gas discharging hole

235a: oxidizing gas supply gap

235b: oxidizing gas discharge gap

237a: seal member

237b: seal member

310: fuel cell system

313: SOFC (fuel cell)

325: air intake line

328: combustion gas supply line

329: combustion exhaust gas line

331: oxidizing gas supply line

332: heat exchanger bypass line

333: exhaust oxidizing gas line

335: control valve

336: control valve

341: fuel gas line

342: control valve

343: exhaust fuel gas line

346: shutoff valve

347: regulating valve

348: recycling blower

349: fuel gas recycling line

350: exhaust fuel gas release line

351: exhaust air cooler

352: control valve

361: purified water supply line

362: pump

370: differential pressure sensor

411: turbocharger

421: compressor

422: catalytic combustor (combustor)

423: turbine

424: rotary shaft

430: heat exchanger

441: orifice (pressure loss unit)

442: waste heat recovery equipment

443: control valve

444: oxidizing gas blow line

445: release valve (air extraction blow valve)

451: control valve

452: blower

453: control valve

454: start-up air supply line

455: start-up air heating line

456: control valve

457: control valve

458: start-up heater

459: control valve

460: control valve

461: catalytic combustion unit

462: pressure equalizing space (pressure equalizing unit)

1. Fuel cell system comprising:
fuel cell having cathode and anode;
a turbocharger having a turbine and a compressor;
exhaust fuel gas line for supplying exhaust fuel gas discharged from the fuel cell to a combustor;
exhaust oxidizing gas line for supplying exhaust oxidizing gas discharged from the fuel cell to the combustor;
combustion gas supply line for supplying combustion gas discharged from the combustor to the turbine;
oxidizing gas supply line for supplying oxidizing gas compressed by the compressor to the cathode by rotationally driven by the turbine;
a regulating valve provided on the exhaust fuel gas line; and
a control unit that controls the regulating valve to control differential pressure between pressure of the cathode and pressure of the anode in the fuel cell, wherein
vent system that releases the exhaust oxidizing gas to outside of the system is not provided on the exhaust oxidizing gas line.

2. The fuel cell system according to claim 1, further comprising:
a pressure equalizing unit that is connected to the exhaust fuel gas line and to the exhaust oxidizing gas line and that equalizes pressures of the exhaust fuel gas and of the exhaust oxidizing gas.

3. The fuel cell system according to claim 2, wherein
the pressure equalizing unit is provided as common space to which the exhaust fuel gas and the exhaust oxidizing gas are supplied in the combustor.

4. The fuel cell system according to claim 2, wherein
the combustor mixes the exhaust fuel gas and the exhaust oxidizing gas at the pressure equalizing unit and combusts the mixed gas at a catalytic combustion unit using a combustion catalyst.

5. The fuel cell system according to claim 1, further comprising:
a pressure loss unit that is provided in the exhaust oxidizing gas line and that adds pressure loss to the exhaust oxidizing gas.

6. The fuel cell system according to claim 1, further comprising:
exhaust fuel gas release line that is connected to the exhaust fuel gas line and that releases the exhaust fuel gas to atmosphere; and
a shutoff valve provided on the exhaust fuel gas release line.

7. The fuel cell system according to claim 6, wherein
the control unit opens the shutoff valve in case where the pressure of the anode against the pressure of the cathode becomes higher than predetermined value.

8. The fuel cell system according to claim 1, further comprising:
blow line connected to the oxidizing gas supply line and through which the oxidizing gas flows; and
a release valve provided on the blow line, wherein
the control unit opens the release valve in case where the pressure of the cathode against the pressure of the anode becomes higher than predetermined value.

9. Method for controlling fuel cell system including fuel cell having cathode and anode, a turbocharger having a turbine and a compressor, exhaust fuel gas line for supplying exhaust fuel gas discharged from the fuel cell to a combustor, exhaust oxidizing gas line for supplying exhaust oxidizing gas discharged from the fuel cell to the combustor, combustion gas supply line for supplying combustion gas discharged from the combustor to the turbine, oxidizing gas supply line for supplying oxidizing gas compressed by the compressor to the cathode by rotationally driven by the turbine, and a regulating valve provided on the exhaust fuel gas line, in which vent system that releases the exhaust oxidizing gas to outside of the system is not provided on the exhaust oxidizing gas line, the method comprising:
controlling the regulating valve to control differential pressure between pressure of the cathode and pressure of the anode in the fuel cell.
